(19) United States
(12) Patent Application Publication
(10) Pub. No.: US 2002/0140191 A1
(43) Pub. Date: Oct. 3, 2002

(54) EZI-HOLD bracket

(76) Inventor: Bernard M. Knowlton, Santa Barbara, CA (US)

Correspondence Address: BERNARD M. KNOWLTON, PO BOX 6464, SANTA BARBARA, CA, 93160, US

(21) Appl. No.: 10/055,832

(22) Filed: Apr. 8, 2002

Related U.S. Application Data
(60) Provisional application No. 60/262,948, filed on Jan. 22, 2001.

(51) Int. Cl. B62B 1/06

(52) U.S. Cl. 280/47.29; 280/47.24

(57) ABSTRACT

The “Add-Ezi-Hold” bracket will be used to facilitate handling of garbage cans or similar containers while using a hand truck. Bracket is designed to fit on center support of hand truck and to slip up and down on the support so as to firmly affix a trash can or other container while moving the hand truck. Container is loaded on the hand truck platform and is tipped or balanced to be in direct contact with back support of the hand truck. Once the container is in this position, bracket is slipped downward with the bottom edge of bracket lip slipping over the rim of the container. This permits hand truck and its load to be moved easily with one hand as opposed to the ungainly method of moving the hand truck with one hand while steadying load (container) with the other hand. To remove the container from hand truck, it is only necessary to lift bracket enough to clear container rim. The use of this bracket simplifies use of the hand truck and eliminates much frustration and anger associated with such use, plus saves much time and effort. Bracket body that fits around the center support of hand truck is designed in a size so that it can be turned around, for instance, in case of using the hand truck for other jobs, the bracket lip can be turned to the rear of hand truck so that it will be out of the way for other types of loads, like a drum or other shapes where the bracket might interfere.

### BACKGROUND OF THE INVENTION

The ADD-EZI-HOLD Bracket will be used to facilitate the handling of garbage cans or other containers while using a hand truck. My other bracket EZI-HOLD was designed for installation during the manufacture of the hand truck but this bracket is designed for use on existing hand trucks. This bracket is installed on the hand truck after the manufacture of the hand truck. In other to do this, the bracket is manufactured with a slot running on a diagonal so it can be slipped over the center support yet will remain on the support for its designed purpose until removed. This bracket is designed to fit on the center support of the hand truck and to slip up and down on the support so as to firmly affix a trash can or other container while moving the hand truck. Once the container is in this position, the bracket is slipped downward with one hand as opposed to the ungainly method of moving the hand truck with one hand while steadying the load container with the other hand. To remove the container from the hand truck, it is only necessary to lift the bracket lip high enough to clear the container rim.

The inventor has no knowledge of a similar device that will perform these functions.

The use of this bracket simplifies the use of the hand truck and eliminates much of the frustration and anger associated with such use, plus saves time and effort. The bracket body that fits around center support of the hand truck can be tubular or square in shape so that it can be turned around in case of using the hand truck for other jobs with other containers, thus the bracket lip can be turned to the rear of the hand truck in order that it will be out of the way for other types of loads.

### SUMMARY OF THE INVENTION

The invention is a device made from two pieces of light metal that is made into a bracket that will hold a container on the shoe plate (bottom plate) of a hand truck that is commonly used by the ordinary family. It eliminates the movement of the load (container) from shifting around on the shoe plate or from sliding off from the shoe plate altogether. Basically it eliminates the need for the use of both hands in the control of the container during any movement of the hand truck. In actual use it permits the full use of one hand for other purposes than for controlling the movement of the hand truck. This invention will be a great attraction for those weekend homeowners who are cleaning up around their home. A great feature about this invention is the fact that it can be added to the hand trucks already in use by adding the Add-Ezi-Hold bracket by the simple act of slipping it on the hand truck, and for those manufacturers who make it, they will welcome the invention's ability to be added to the hand truck during the process, by eliminating the diagonal cut and making it a part of the initial manufacture. Most importantly, the hand truck owners will celebrate the day that the invention becomes available to them.

### DETAILED DESCRIPTION OF THE INVENTION

This invention is a simple idea to relieve the homeowner, the gardener, and anyone who is moving containers, performing garden work, cleaning up around the home to perform those activities with more efficiency, less work, and a generous saving of time and with more energy. By attaching this invention to the hand truck, it completely changes a person's outlook of work to be accomplished with much less frustration and anger.

The invention is manufactured from strap lengths of light metal that offers easy methods of construction and with the low cost of material should offer to the buying public a strong, flexible way to enjoy the manner in which these tiresome chores are performed with this invention. The invention will hold the containers in a firm, steady manner that will surprise the most doubtful users-to-be.

### BRIEF DESCRIPTION OF THE DRAWINGS

FIG. 1 is a front view and FIG. 1A is a side view of the typical hand truck for which this invention has been designed.

FIG. 2 is a top and side view of the invention.

FIG. 3 is a top view and front view of the invention.

FIG. 4 is a front view of the hand truck loaded with the container.

### DETAILED DESCRIPTION OF THE EMBODIMENTS

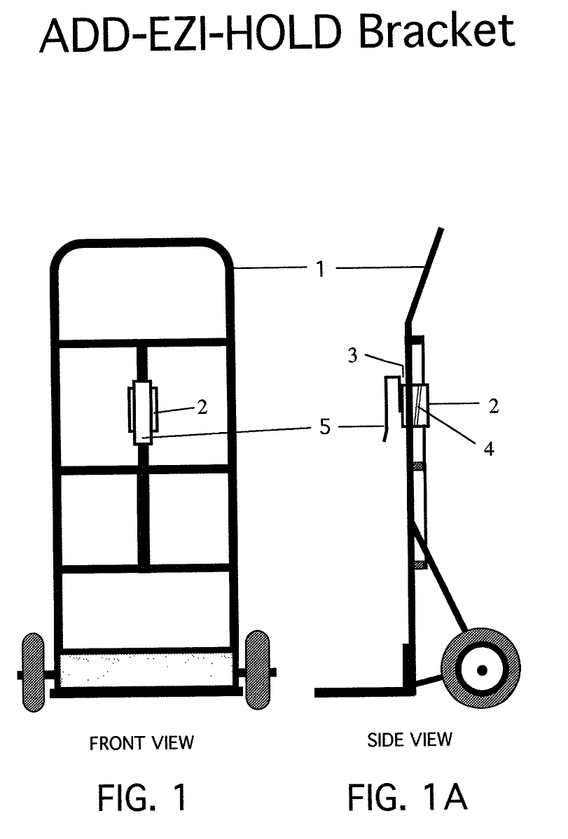

FIG. 1 and FIG. 1A show the the hand truck as indicated by 1. Indicated by 2 in FIG. 1 and FIG. 1A is the invention attached to the center support of the hand truck with the side view clearly showing the bracket lip 5 which slips down over the container rim to hold the container tightly against the hand truck. 3 in the side view FIG. 1A indicates the slot available to hang buckets or other containers with wire handles. 4 in FIG. 1A shows diagonal cut in bracket for installing invention on the center support of hand truck.

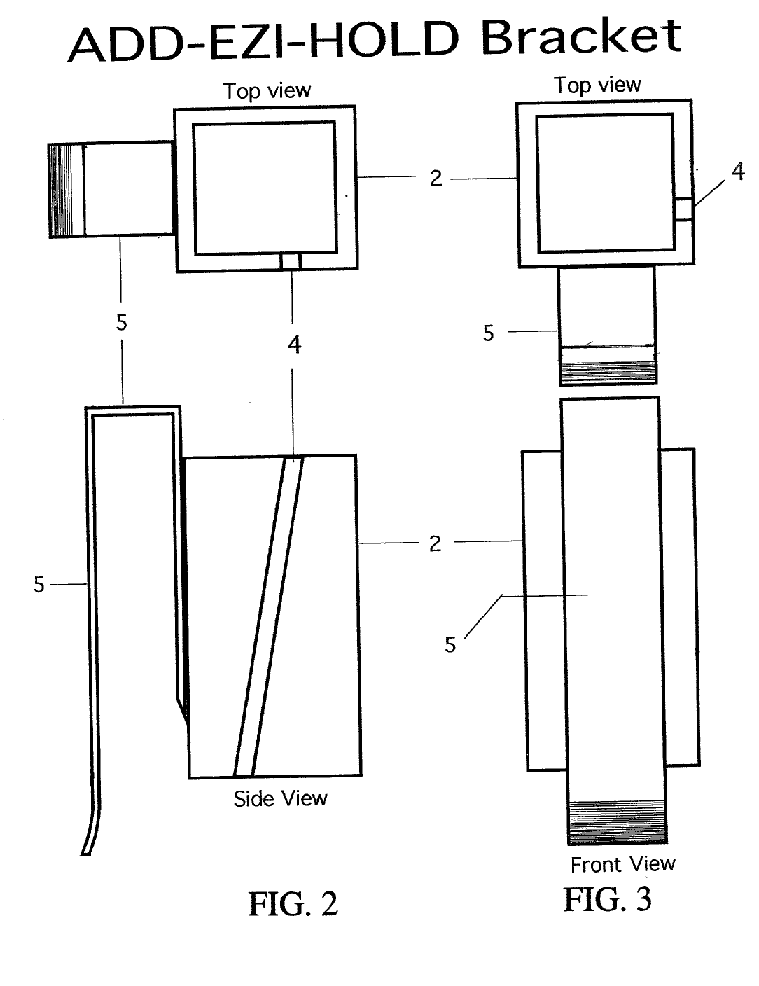

FIG. 2 shows the top view and the side view of the invention with 2 indicating the body of the invention, in this case, it is square but it could be round. 4 shows the diagonal cut in one side of the bracket. The bracket lip is indicated by 5.

FIG. 3 shows the top view and the front view, all numbers pertain to the same items as indicated in FIG. 2.

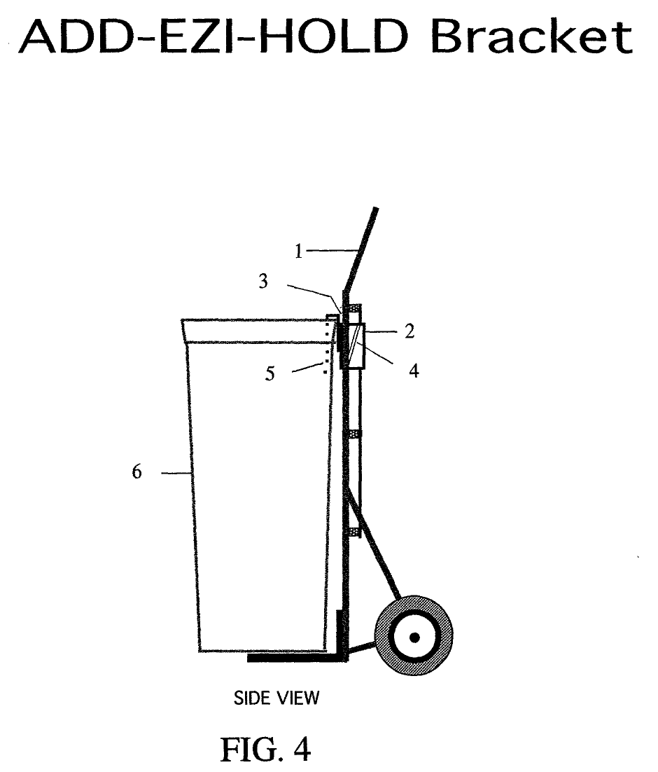

FIG. 4 shows the side view of the hand truck engaged with the container by the invention bracket. 1 indicates the hand truck, 2 shows the bracket mounted on the center support, 3 indicates the slot which is available to hang buckets or other containers with wire handles, with 4 indicating the diagonal cut which enables the bracket to slip over the center support, 5 indicates the lip of the bracket over the rim of the container and into its interior as shown by the dotted line, 6 indicates the container such as a garbage can.

1. What I claim as my invention is a metal bracket that fits around the center support bar of a hand truck and by moving it up and down on the center support bar to a position where it will slip over the rim of a container as it it is loaded onto the bottom ledge of the hand truck, thereby holding the container in place on the hand truck.
The metal bracket is made with a diagonal cut across one side lengthwise so that it can be removed from the top section of the center support bar and move it down to be placed on the lower section of the center support bar.
The move is possible by lining the diagonal cut in the bracket with the center support and remove it and by the same procedure in reverse, place it where it is needed on the lower section of the center support, or it need not be installed if it interferes with other container shapes and sizes.

2. I further claim that by not cutting the diagonal across the bracket, the design can then be installed on the hand truck during the original manufacture and will perform all the tasks the same as the bracket installed after the manufacture of the hand truck except that it cannot be moved down to the lower section of the center support.
